(19) United States
(12) Patent Application Publication
(10) Pub. No.: US 2002/0186727 A1
(43) Pub. Date: Dec. 12, 2002

(54) Optical transmitting apparatus and manufacturing method thereof

(76) Inventor: Masahiro Aoki, Kokubunji (JP)

Correspondence Address: REED SMITH LLP, Suite 1400, 3110 Fairview Park Drive, Falls Church, VA, 22042, US

(21) Appl. No.: 10/080,587

(22) Filed: Feb. 25, 2002

(30) Foreign Application Priority Data
May 23, 2001 (JP) 2001-153350
Oct. 2, 2001 (JP) 2001-305926

(51) Int. Cl. H01S 3/10; H01S 3/00

(52) U.S. Cl. 372/26; 372/38.02

(57) ABSTRACT

To realize an optical transmitting apparatus at reasonable cost which can be appropriately used for a high-speed optical communication using an optoelectronic integrated circuit. More specifically, it is to realize an optoelectric integrated circuit without using an expensive InP substrate, thereby reducing the size and cost of the optical transmitting apparatus and obtaining a high performance. To achieve the aforementioned object, the present invention uses a GaAs substrate to constitute an optoelectronic integrated circuit operating at the wavelength appropriate for communication use. By properly selecting an active layer material and configuration of the optical element, we could realize operation in the 1.3-micrometer wavelength band or 1.55-micrometer band.

### BACKGROUND OF THE INVENTION

1. Field of the Invention

The present invention relates to an optical transmitting apparatus and its manufacturing method or an optical transfer apparatus. More specifically, the present invention relates to a semiconductor laser and its drive circuit, an optical element for external modulation of output light from a semiconductor laser and optoelectronic monolithic integrated circuit (OEIC) of its drive circuit and in particular to an optical transmitting apparatus appropriate for a high-speed optical communication system of 10 giga bits per second or above.

2. Description of the Related Art

The main components of the optical transmitting apparatus used for optical communication are a laser light source and a laser driver circuit in case of direct modulation method. Moreover, in case of the external modulation method, the main components are a laser light source, an optical modulator, and an optical modulator driver circuit. These basic components are set to operation wavelength of 1.3-micrometer band or 1.55-micrometer band from the viewpoint of the silica-based optical fiber.

On the other hand, in terms of transfer speed, 10-giga bit per second is already used in practice and 40-giga bit speed has began to be used in practice. In these super high-speed optical transmitting apparatus, the optical part and the electronic part should be connected by a high-speed electric signal. Especially for the high-speed modulation of 40 giga bits or above, the electric connection between the optical and electronic components decides the high-speed performance of the transmitting apparatus. For this, high-speed mounting technique has become an important target to decide the performance. To solve this problem, monolithic integration of the optoelectronic components is considered. There has been a report on an integration of an optical detector using an InP substrate and operable at 40 giga bits per second and a preceding-stage amplifier (the 25^{th} Optical Fiber Communication International Conference, OFC2000, paper FG4). Moreover, Japanese Patent Publication (JP-A-09-213918) discloses integration of GaAs-based electronic element and a semiconductor laser or an optical detector operable in the 1.3-micrometer wavelength band or above, by using GaInNAs semiconductor crystal on a GaAs substrate.

In case of the optoelectronic integrated circuit, during wafer processing, electric connection between the optical and electronic components is realized with a high accuracy and the aforementioned problem can be solved. On the other hand, when implementing this in the 1.3-micrometer or 1.55-micrometer band for optical communication, from the viewpoint of the corresponding band gap energy, use of the conventional InP substrate has been indispensable. However, the InP substrate using indium having a low Clarke index costs much higher than the silicon substrate and the GaAs substrate and the InP substrate used in practice has a problem that the substrate size is small, i.e., not greater than 3 inches. This is one of the obstacles for spreading the optoelectronic integrated circuit using the InP substrate. On the other hand, the optoelectronic integrated circuit using the GaAs substrate which can be obtained in a large diameter up to 6 inches is by far excellent as compared to the InP from the view point of high performance at low cost but the operation wavelength is not greater than 1.2 micrometers and is not appropriate for an optical communication using a silica-based optical fiber. Moreover, as compared to InP-based crystal containing a large amount indium, in the GaAs-based crystal, the movement amount of electrons is small and accordingly, from the viewpoint of high-speed electronic device, the GaAs-based crystal is not appropriate for super high-speed operation.

On the other hand, when consideration is taken on the optical modulation method, in the super high-speed transfer of 40 giga bits per second, it is considered that the external modulation method will be mainly used, i.e., a laser light source is intensity-modulated by using an optical modulator. This is because the fiber transfer distance is determined by the optical fiber dispersion and the light source frequency fluctuation. From this viewpoint, in the direct modulation method of a laser having a large frequency fluctuation, the transfer distance of an ordinary silica fiber is limited to several kilometers.

### SUMMARY OF THE INVENTION

It is therefore an object of the present invention to provide a high-speed optical communication system using an optoelectronic integrated circuit and in particular to provide an optical transmitting apparatus having a long fiber transfer distance at low cost.

In order to achieve the aforementioned object, we have devised a configuration method of an optoelectronic integrated circuit by using a GaAs substrate for operating in a wavelength band for communication. Moreover, by forming an external modulator on the GaAs substrate, it was possible to device a configuration method of an optoelectronic integrated circuit capable of operating for the external modulation method which is indispensable for increase of the fiber transmitting distance. Moreover, by devising an active layer material and configuration of the optoelectdronic integrated circuit, we could realize operation at the wavelength band of 1.3 micrometers or 1.55 micrometers and obtain super high speed of the electronic device. Table 1 shows comparison of features of the GaAs substrate with InP substrate and active layer materials when applied to the electronic device and optical device.

TABLE 1

| | | | | | Electronic | |
|---|---|---|---|---|---|---|
| | | | | Optical device | device active | |
| | | | | active layer | layer material | |
| | Cost ratio | | | material | (channel | |
| Crystal | (per unit | | | (for fiber | layer/electron | Electronic device |
| substrate | area) | Size | Hardness | communication) | supply layer) | butter material |
| GeAs | 1 | 6 inch | 750 | GeInNAs | GaAs/AlGaAs | Grating match |
| | | | | quantum well | InGaAs/AlGaAs | (including quasi- |
| | | | | GaInNAsSb | InGaAs/InGaP | grating match |
| | | | | quantum well | | system) |
| | | | | GaAsSb quantum | | GaAs/AlₓGa₁₋ₓAs |
| | | | | well | InGaAs/InAlAs | Grating non-match |
| | | | | InGaAs quantum | InGaAs/InP | (metamorphic) |
| | | | | dot | | In_{y}Ga_{1-y}As/In_{z}Al_{1-z}As |
| InP | 5 | 3 inch | 530 | InGaAsP | InGaAs/InAlAs | InP |
| | | | | quantum well | InGaAs/InP | In_{0.52}Al_{0.48}As |
| | | | | InGaAlAs | | |
| | | | | quantum well | | |

As shown in the Table, when the substrate diameter (size) and substrate cost (shown in cost ratio) are concerned, it is clear that the GaAs substrate is much better than the InP substrate. Accordingly, if a light source material having a wavelength band appropriate for optical fiber communication, i.e., 13.3 micrometer band or 1.55 micrometer band is integrated with en electronic device material on the GaAs substrate, it is possible to drastically reduces the cost of the optolelectronic integrated element for optical communication.

The GaAs substrate has a large diameter and its cost per area is much less than the InP substrate. Table 1 shows materials of the optical device and the electronic device to be integrated on the GaAs substrate so as to constitute an optoelectronic integrated element operating in the 1.3-micrometer band or 1.55-micrometer band. The light source devices of the 1.3-micrometer and 1.55-micrometer wavelength band can be formed on the GaAs substrate as a quantum well structure using GaInNAs, GaInNAsSb, GaAsSb or a quantum dot structure using GaInAs. On the other hand, the electronic device is divided into a grating match system including a quasi grating match system and a grating non-match system (metamorphic system), which can be composed of a combination of the channel layer and the carrier supply layer materials as show in Table 1. Accordingly, it is possible to monolithically integrate optical components such as a semiconductor laser light source and an optical modulator and a driver circuit for electrically driving these on the GaAs substrate, thereby realizing an optoelectdronic integrated circuit capable of operating in a wavelength band appropriate for optical communication using silica fiber. Especially when applying the metamorphic system, the super high-speed electron element which has conventionally been formed on the InP substrate can be formed on the GaAs substrate, thereby drastically improving the operation speed of the optoelectronic integrated circuit on the conventional GaAs substrate. Meanwhile, the electronic device possibly comprises a thin film crystal layered on the semiconductor substrate through a semiconductor buffer layer, the thin film crystal having a different crystal constant perpendicular to the substrate crystal face from the substrate more than 1.0%, and has a lattice non-match system crystal structure.

FIG. 1 shows a conventional configuration in which optical components and electronic components are hybrid-mounted. As shown in FIG. 1, the conventional optical transmitting apparatus includes a semiconductor laser light source 101 and an optical modulator 102 which are optically connected to each other by an optical fiber 103. Moreover, a multiplexer circuit 105 and a modulator driver 104 are connected as external components using a high-frequency line 106, and the modulation driver 104 is also connected to the optical modulator 102 from outside. In this configuration, the optical coupling efficiency is lowered and there arises a problem to obtain a preferable transfer characteristic of a high-frequency electric signal. This problem becomes especially remarkable when the frequency band becomes 40 GHz or above. FIG. 2 a conceptual figure of an optical transmitting apparatus according to the present invention, and shows an optical transmitting apparatus configuration having a built-in 1.55-micrometer band waveguide type optical modulator. In this figure, the semiconductor laser light source 101, the monolithic integration of the optical modulator 102, and the modulator driver 104 of the conventional configuration of FIG. 1 are monolithically integrated on the GaAs substrate requiring a low cost and having a large diameter. Here, the optoelectronic monolithic integrated element 110 is composed of a semiconductor laser block 111, an optical modulator block 112, and optical modulator drive circuit block 113. The multiplexer circuit 105 and the optical modulator drive circuit block 113 are connected from outside by using the high-frequency line 106. When these components are monolithically integrated, it is possible not only reduce the apparatus size and power consumption but also to drastically improve the transfer characteristic of the high-frequency electric signal. The reference symbol 103 denotes an optical fiber for taking an optical signal out. The multiplexer circuit which is a separate component in this configuration may be monolithically integrated according to the present invention. Next, explanation will be given on more specific configuration of the optoelectronic monolithic integrated element 110 and production method thereof.

Other objects, features and advantages of the invention will become apparent from the following description of the embodiments of the invention taken in conjunction with the accompanying drawings.

### BRIEF DESCRIPTION OF THE DRAWINGS

FIG. 1 is a top view showing a configuration concept of a conventional optical transmitting apparatus.

FIG. 2 is a top view showing a configuration concept of an optical transmitting apparatus according to the present invention.

FIG. 3A shows crystal growth steps of the optoelectronic integrated element according to the present invention.

FIG. 3B shows crystal growth steps of the optoelectronic integrated element according to the present invention.

FIG. 3C shows crystal growth steps of the optoelectronic integrated element according to the present invention.

FIG. 4A shows crystal growth steps of the optoelectronic integrated element according to the present invention.

FIG. 4B shows crystal growth steps of the optoelectronic integrated element according to the present invention.

FIG. 5 is a top view showing a distribution feed-back type laser having a wavelength band of 1.3 micrometers and its drive circuit which are monolithically integrated according to an embodiment of the present invention.

FIG. 6 is a top view showing a face light emitting type laser having a wavelength band of 1.3 micrometers and its drive circuit which are monolithically integrated according to an embodiment of the present invention.

FIG. 7 is a top views showing an interference type optical modulator operating in both 1.3-micrometer and 1.55-micrometer bands and its drive circuit monolithically integrated according to an embodiment of the present invention.

FIG. 8 is a top view showing a distribution feed-back type laser having a wavelength band of 1.3 micrometers, an interference type optical modulator, and a drive circuit thereof which are monolithically integrated according to an embodiment of the present invention.

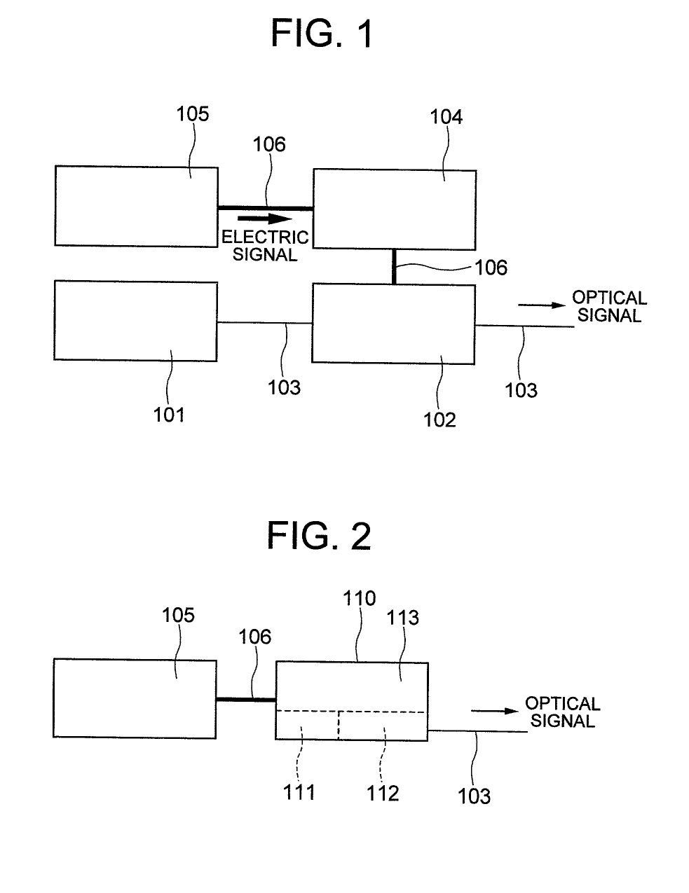

### DETAILED DESCRIPTION OF THE EMBODIMENTS

Description will now be directed preferred embodiments of the present invention with reference to the attached drawings.

<Embodiment 1>

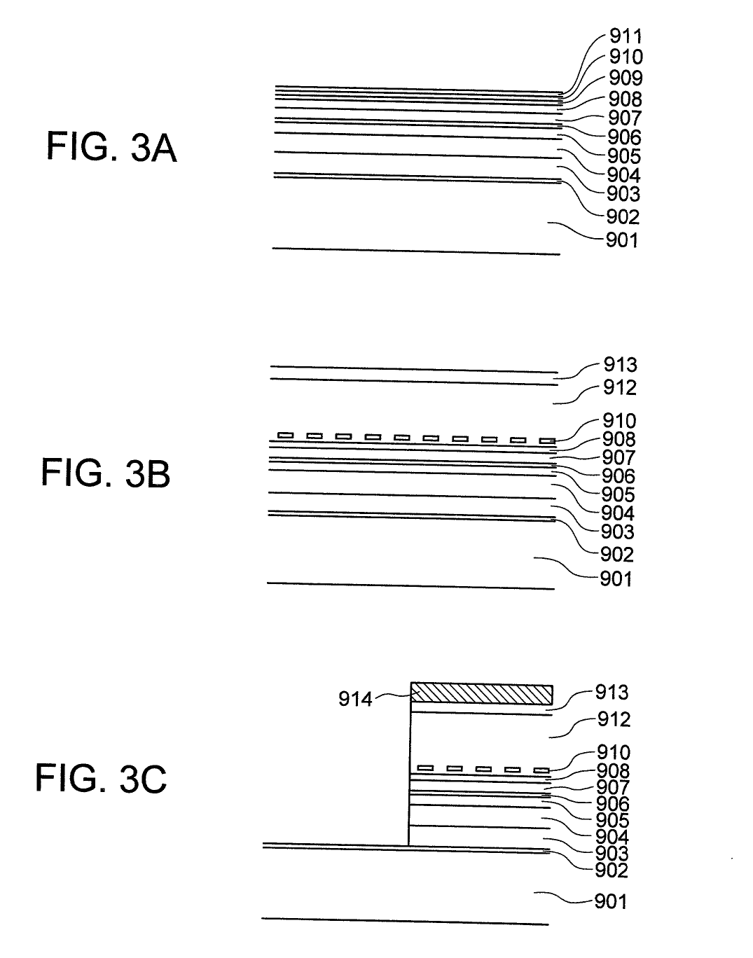

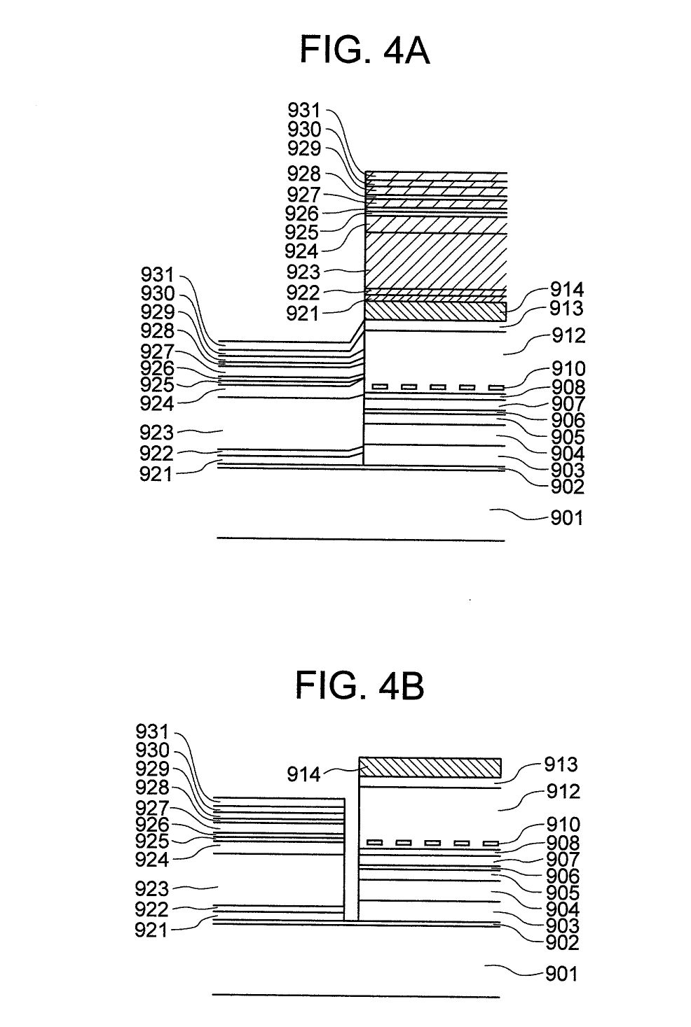

Firstly, explanation will be given on an example of a distribution feed-back type laser and its drive circuit of high electron movement transistor structure which are integrated by metamorphic growth according to an embodiment. FIG. 3A to FIG. 3C, FIG. 4A and FIG. 4B show crystal growth steps which are the main part of the optoelectronic integrated element production procedure. The procedure is roughly divided into a semiconductor laser crystal growth (FIG. 3A and FIG. 3B), partial removal of the semiconductor laser crystal (FIG. 3C), drive circuit crystal growth (FIG. 4A), and a partial removal of the drive circuit crystal (FIG. 4B). As shown in FIG. 3A, on a large-diameter semi-insulating GaAs substrate 901 are successively grown by using solid material molecule beam crystal growth method: an n-type InGaP etching stop layer 902 having a thickness of 50 nm; an n-type GaAs buffer layer 903 having a thickness of 300 nm; an n-type GaAs buffer layer 904 having a thickness of 700 nm; an undope GaAs lower light guide layer 905 having a thickness of 100 nm; an undope GaInNAs quantum well layer; a 3-cycle multi-quantum well layer 906 having an undope GaAs as a quantum barrier layer; an undope GaAs upper light guide layer 907 having a thickness of 100 nm; a p-type GaAlAs etching stop layer 908 having a thickness of 30 nm; a p-type GaInP diffraction grating spacer layer 909 having a thickness of 50 nm; a p-type GaAs diffraction grating supply layer 910 having a thickness of 50 nm, and a p-type GaInP cap layer 911. Subsequently, by using the known interference exposure method and the wet etching, a diffraction grating of 20 nm cycle is formed. After this, by using the organic metal gaseous layer growth method, the diffraction grating layer is covered with a p-type GaInP clad layer 902 having a thickness of 1500 nm and a p-type high concentration GaAs electrode contact layer 913 having a thickness of 300 nm (FIG. 3B). This completes the crystal structure of the 1.3-micrometer band distribution feed-back type laser.

Next, a silicon oxide mask 914 is formed in the vicinity of the area where a laser stripe is to be formed, and the aforementioned crystal growth layer is etched by using the wet etching. For the wet etching, a mixture of sulfuric acid, hydrogen peroxide, and water is used to remove the crystal layer containing arsenic, and a mixture of hydrochloric acid and phosphoric acid is used to remove the GaInP layer. Lastly, as shown in FIG. 3C, the etching is terminated at the n-type InGaP etching stop layer 902.

Next, a crystal for the laser drive circuit is grown. By using the gas material molecule beam crystal growth method, as shown in FIG. 4A, following layers are successively formed: an undope GaAs buffer layer 921 having a thickness of 50 nm; an undope AlAs buffer layer 922 having a thickness of 50 nm, an InAlAs graded buffer layer 923 containing indium composition linearly changed from 0 to 0.5 and having a thickness of 1000 nm; an undope InAlAs buffer layer 924 containing indium 0.5 and having a thickness of 200 nm; an InP etching stop layer 925 having a thickness of 5 nm; an undope InAsP layer 926 having a thickness of 5 nm; a three-layered channel layer of undope InGaAs layer 927 containing indium 0.5 and having a thickness of 20 nm; an undope InAlAs spacer layer 928 containing indium 0.5 and having a thickness of 2 nm; an n-type InAlAs carrier supply layer 929 containing indium 0.5 and having a thickness of 12 nm; an undope InAlAs spacer layer 930 containing indium 0.5 and having a thickness of 10 nm; and a high concentration n-type InGaAs electrode contact layer 931 containing indium 0.5 and having a thickness of 10 nm. Here, on the silicon oxide mask 914, a part of the crystal for the laser drive circuit is accumulated as multi-crystal. This multi-crystal portion 932 can be removed by a known method. Lastly, as shown in FIG. 4B, on the same GaAs substrate, a semiconductor layer formed from an optical crystal emitting light at 1.3 micrometers appropriate for fiber optical communication and a laser drive circuit are monolithically integrated. By using the aforementioned crystal structure, it is possible to use the optoelectronic integrated element on the GaAs substrate for fiber optical communication which has been impossible conventionally.

It should be noted that in this embodiment, explanation has been given on a high electron movement transistor structure as the electronic element. However, the effects of the present invention can also obtained when using a field effect transistor structure and a hetero-bipolar transistor.

<Embodiment 2>

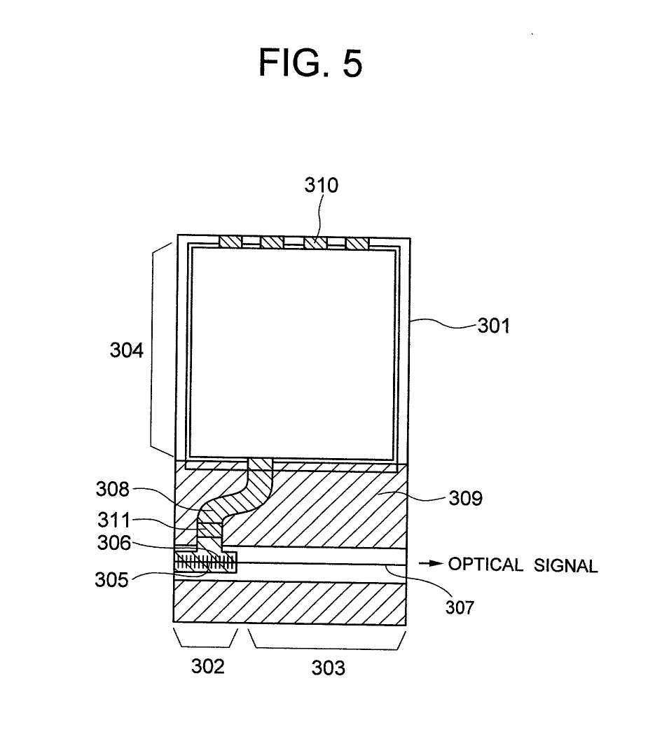

FIG. 5 is a top view showing the semiconductor laser of 1.3-micrometer wavelength band whose crystalline structure and production method have been explained in Embodiment 1 and its drive circuit which are monolithically integrated on the GaAs substrate. The element formed on the GaAs substrate 301 can roughtly be divided into a semiconductor laser block 302, an external waveguide portion 303 for introducing the laser output, and a laser drive circuit 304. Here, the external waveguide portion 303 is additionally integrated because the size of the semiconductor laser portion 302 is quite different from the size of the laser drive circuit 304 and the external waveguide portion 303 does not necessarily have to be provided. In the figure, 306 denotes a laser upper electrode, 307 denotes an output waveguide, 308 denotes a drive signal output block, 309 denotes a substrate grounding block, 310 denotes a drive signal input block, and 311 denotes an impedance matching resistor. Here, the semiconductor laser is a distribution feed-back type laser of 1.3-micrometer wavelength band having a GaInNAs having quantum well layer and a diffraction grating 305. By using the GaInNAs material, it becomes possible to monolithically integrate a semiconductor laser emitting light of a wavelength appropriate for fiber transfer on the GaAs substrate. The drive circuit 304 is composed of a hetero bipolar transistor having an InGaAs active layer or high electron movement transistor. As the undercoat material of the drive circuit 304, it is possible to use the GaAs as it is or InP grown on the GaAs by a known metamorphic growth. The high frequency output of the drive circuit 304 is applied directly to the semiconductor laser portion 302 via the drive signal output block and the inpedance matching resistor 311. Here, the output and input are designed in advance so as to obtain a preferable electric connection by the integration circuit technique. More specifically, The design is determined so that the high frequency line is set to have a characteristic impedance in the vicinity of 50 ohms, which can easily be performed by using a known technique. Accordingly, it is possible to obtain preferable reproducibility of reflection characteristic of an electric signal between the drive circuit 304 and the semiconductor laser block 302.

Moreover, as a new feature, when a chip temperature control apparatus is used in this configuration, the temperature control apparatus can be shared by the drive circuit 304 and the semiconductor laser block 302 and accordingly, it is possible to reduce the size of the transmitting apparatus and reduce the production cost. According to this configuration, it is possible to realize a small-size optical transmitting apparatus using a high-speed direct modulation of 40 giga bits or above per second.

<Embodiment 3>

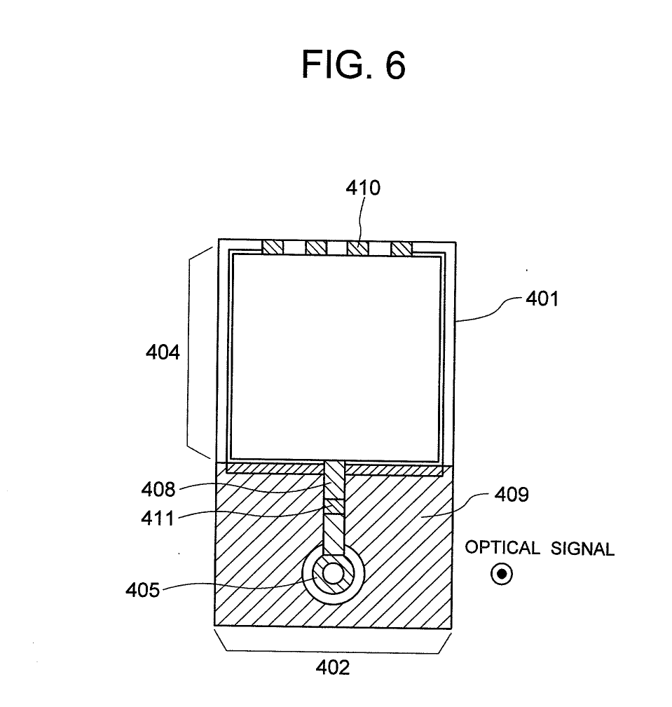

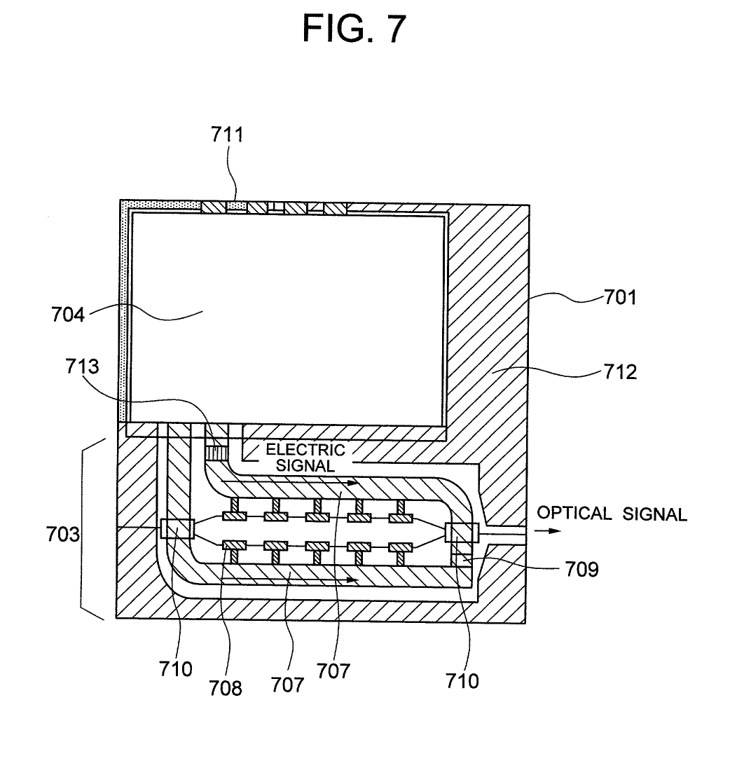

FIG. 6 is a top view of an embodiment in which the distribution feed-back type laser of Embodiment 1 is replaced by a face light emitting type laser. This embodiment is an optical transmitting apparatus having a 1.55-micrometer wavelength band. Like in the second embodiment, the active layer of the face light emitting type laser has a multi-quantum well structure using a GaInNAs as a quantum well layer and oscillation wavelength in the vicinity of 1.3 micrometers. The face light emitting laser has a known configuration in which the multi-quantum well structure is sandwiched by semiconductor distribution black reflectors. In this embodiment, the face light emitting type laser has an electric resistance as large as about 90 ohms and accordingly, the characteristic impedance of the high frequency line is set in the vicinity of 100 ohms. For this, the output impedance of the drive circuit 404 and the impedance matching resistor 411 are designed in accordance with this. By using this configuration, it is possible to realize a small-size transmitting apparatus using high-speed direct modulation of 10 giga or above per second.

<Embodiment 4>

FIG. 7 is a top views showing an interference type optical modulator 703 operating in both 1.3-micrometer and 1.55-micrometer bands and its drive circuit 704 which are monolithically integrated on a GaAs substrate 701. The interference type optical modulator 703 has a progressive wave type electrode connected to a modulator electrode 708 periodically arranged in the high frequency line 707. The modulator has an optical control layer formed from two of the materials: GaAs, InGaAs, AlGaAs. The layered structure may be a bulk layer or a quantum well layer. However as will be described later, the quantum well layer has better modulator drive voltage characteristic. The optical interference waveguide has a known configuration in which a wavelength multiplexer/demultiplexer 710 is connected to each of an input waveguide and an output waveguide.

The drive circuit 704 is composed of a hetero-bipolar transistor having an InGaAs active layer or an integrated circuit using a high electron movement transistor. As an undercoat material of the drive circuit 704, it is possible to directly use the GaAs or InP grown on the GaAs by the known metamorphic growth. The high frequency output of the drive circuit 704 outputs data having an identical amplitude as ordinary data but reversed polarity from a pair of drive signal output blocks directly to a pair of high frequency lines 707. When the two high-frequency line 707 has different effective lengths, a delay device 713 can be inserted so as to match the phases of the two optical interference waveguide. But this is not essential to the present invention. With this configuration, the high-frequency output is then effectively supplied to the aforementioned progressive wave type electrode, thereby realizing a so-called push-pull operation of the interference type optical modulator.

Similarly as the second embodiment, when a chip temperature control device is applied to this configuration, the temperature control device can be shared by the drive circuit 304 and the semiconductor laser block 302 and accordingly, it is possible to provide a small-size transmitting apparatus at a low cost. By using this configuration, it is possible to realize a small-size optical transmitting apparatus using a high-speed external modulation of 40 giga or above per second.

<Embodiment 5>

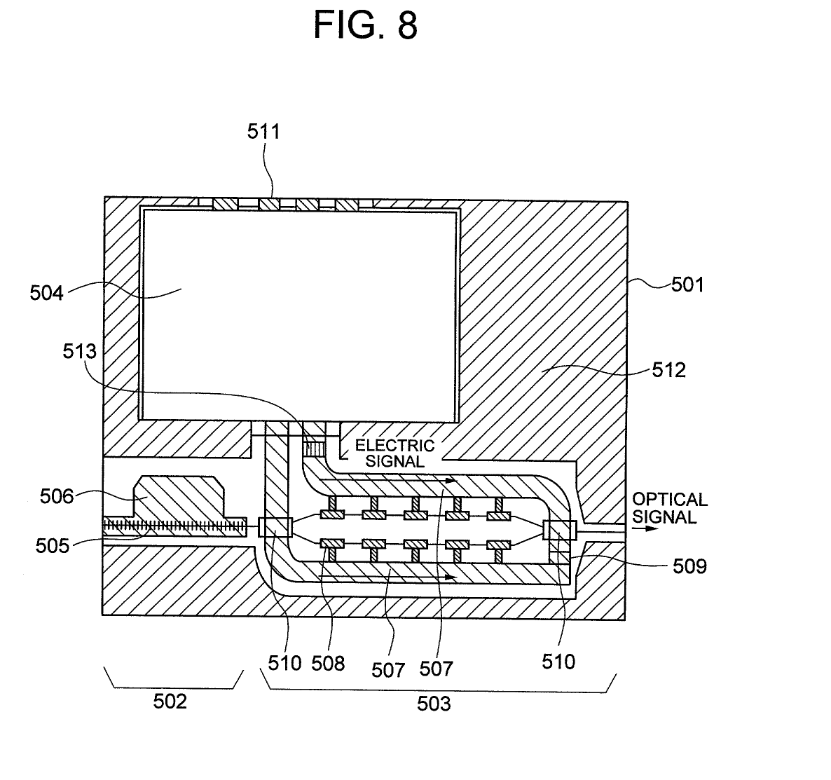

FIG. 8 shows an integrated circuit configuration of Embodiment 3 which is monolithically integrated with a semiconductor laser light source 502 operating in the 1.3-micrometer wavelength band.

Here, the semiconductor laser 502 is a distribution feed-back type laser of 1.3-micrometer wavelength band having a GaInNAs quantum having well layer and a diffraction grating 505. By using the GaInNAs material, it becomes possible to monolithically integrate a semiconductor laser emitting light of wavelength appropriate for fiber transfer on the GaAs substrate. Thus, Embodiment 4 has an effect to further reduce the size of the transmitting apparatus.

Moreover, when this embodiment does not use the drive circuit 704 of the interference type optical modulator 703, a laser light source and an external optical modulator are monolithically integrated on the GaAs substrate so as to form an optical integrated element.

As thus far been described, by using a GaInNAs material as a light source, it is possible to realize an optoelecctronic integrated circuit on the GaAs substrate so as to operate with a wavelength band appropriate for optical fiber communication. This improves the high performance and reduce size of the optical transmitting apparatus at a low cost. As for the wavelength band, explanation has been given on a case of 1.3-micrometer band whose implementation has been currently confirmed. However, by increasing the nitrogen composition, it is possible to increase the wavelength band to 1.55-micrometer band. Moreover, as the light emitting material, it is also possible to use the following instead of the GaInNAs material: a GaAsASb material and a GaInNAsSb material to obtain the same effect as the present invention. Moreover, the same effect as the present invention can also be obtained when using a quantum line structure or quantum dot structure of GaInAs and GaInNAs.

In the optical transmitting apparatus according to embodiments of the present invention, by using a GaAs substrate having a greater diameter and requiring low cost as compared to the conventional InP substrate, it is possible to realize an optoelectronic integrated circuit appropriate for a high-speed optical communication system. In particular, it is possible to realize an optoelectronic integrated circuit operating in the 1.3-micrometer wavelength band and 1.55-micrometer wavelength band which are the wavelength windows of the ordinary silica fiber. As a result, the high-speed optical communication system using this can reduce in seize and improve performance at a reasonable cost. The production cost is reduced by one order as compared to a case using the conventional InP.

It should be further understood by those skilled in the art that the foregoing description has been made on embodiments of the invention and that various changes and modifications may be made in the invention without departing from the spirit of the invention and scope of the appended claims.

What is claimed is:

1. An optical communication apparatus in which at least one of a semiconductor laser serving as an input light source and an electronic device for controlling optical modulator, and an optical modulator for intensity modulation of the output light from the semiconductor laser are monolithically formed on a single GaAs semiconductor substrate, and a signal light in the optical device has a wavelength in a range not smaller than 1.15 micrometers and not greater than 1.62 micrometers.

2. An optical communication apparatus as claimed in claim 1, wherein the optical modulator is of light interference type having a progressive wave type electrode.

3. An optical communication apparatus as claimed in claim 1, wherein an active layer material of the semiconductor laser contains galium and arsenic and one selected from a group consisting of indium, aluminum, nitrogen, and antimony.

4. An optical communication apparatus as claimed in claim 1, wherein the active layer of the semiconductor laser has at least one of the quantum well structure, quantum line structure, or quantum dot structure.

5. An optical communication apparatus as claimed in claim 1, wherein a signal light in the optical device has a wavelength value capable of optical signal transmitting by an optical fiber using a glass material.

6. An optical communication apparatus comprising an optical device and an electronic device for controlling the optical device which are arranged on a single GaAs semiconductor substrate and which are electrically connected by a wiring provided on the substrate,
wherein the optical device has an active layer including at least one selected from a group consisting of a GaInNAs quantum well, a GaInNAsSb quantum well, a GaAsSb quantum well and an InGaAs quantum dot; and the electronic device has an active layer formed from at least one of the following combinations: InGaAs/InAlAs, InGaAlAs/InAlAs, or InGaAs/InP.

7. An optical communication apparatus as claimed in claim 6, wherein the electronic device comprising a thin film crystal layered on the semiconductor substrate through a semiconductor buffer layer, the thin film crystal having a different crystal constant perpendicular to the substrate crystal face from the substrate more than 1.0%, and having a lattice non-match system crystal structure.

8. An optical communication apparatus as claimed in claim 7, wherein the buffer layer contains at least one selected from a group consisting of GaAs, AlGaAs, and InAlAs.

9. An optical communication apparatus as claimed in claim 6, wherein the active layer of the semiconductor laser contains gallium and arsenic and one selected from a group consisting of indium, aluminum, nitrogen, and antimony.

10. An optical communication apparatus as claimed in claim 6, wherein the active layer of the semiconductor laser has at least one selected from a group consisting of the quantum well structure, quantum line structure and quantum dot structure.

11. An optical communication apparatus as claimed in claim 6, wherein a signal light in the optical device has a wavelength value capable of optical signal transmitting by an optical fiber using a glass material.

12. An optical communication apparatus production method comprising steps of:
successively forming a buffer layer and an active layer of an optical device on a GaAs semiconductor substrate;
removing a part of the buffer layer and the active layer; and
successively forming a buffer layer and an active layer of an electronic device in that removed portion;
wherein contains at least one selected from a group consisting of a GaInNAs quantu well, a GaInNAsSb quantum well, a GaAsSb quantum well, and an InGaAs quantum dot; and the active layer of the electronic device is formed from at least one of the following combinations: InGaAs/InAlAs, InGaAlAs/InAlAs, or InGaAs/InP.

13. An optical communication apparatus as claimed in claim 12, wherein the elecronic device comprising a thin film crystal layered on the semiconductor substrate through a semiconductor buffer layer, the thin film crystal having a different crystal constant perpendicular to the substrate crystal face from the substrate more than 1.0%, and having a lattice non-match system crystal structure.

14. An optical communication apparatus production method as claimed in claim 13, wherein the buffer layer contains at least one selected from a group consisting of GaAs, AlGaAs, and InAlAs.

15. An optical communication apparatus production method as claimed in claim 12, wherein the active layer of the semiconductor laser contains gallium and arsenic and one selected from a group consisting of indium, aluminum, nitrogen, and antimony.

16. An optical communication apparatus production method as claimed in claim 6, wherein the active layer of the semiconductor laser has at least one selected from a group consisting of the quantum well structure, quantum line structure and quantum dot structure.

17. An optical communication apparatus production method as claimed in claim 12, wherein a signal light in the optical device has a wavelength value capable of optical signal transmitting by an optical fiber using a glass material.
